(19) United States
(12) Patent Application Publication
(10) Pub. No.: US 2022/0358388 A1
(43) Pub. Date: Nov. 10, 2022

(54) MACHINE LEARNING WITH AUTOMATED ENVIRONMENT GENERATION

(71) Applicant: INTERNATIONAL BUSINESS MACHINES CORPORATION, Armonk, NY (US)

(72) Inventors: Long Vu, Chappaqua, NY (US); Dharmashankar Subramanian, White Plains, NY (US); Peter Daniel Kirchner, Putnam Valley, NY (US); Eliezer Segev Wasserkrug, Haifa (IL); Lan Ngoc Hoang, Lymm (GB); Alexander Zadorojniy, Haifa (IL)

(21) Appl. No.: 17/316,103

(22) Filed: May 10, 2021

(51) Int. Cl. G06N 7/00; G06N 3/04; G06N 3/08

(52) U.S. Cl. CPC G06N 7/005; G06N 3/0454; G06N 3/084

(57) ABSTRACT

Methods and systems for generating an environment include training transformer models from tabular data and relationship information about the training data. A directed acyclic graph is generated, that includes the transformer models as nodes. The directed acyclic graph is traversed to identify a subset of transformers that are combined in order. An environment is generated using the subset of transformers.

### BACKGROUND

The present invention generally relates to machine learning, and, more particularly, to the automated generation of environment information that may be used for various purposes, such as reinforcement learning.

Certain machine learning techniques, such as reinforcement learning, may use a predetermined environment, where an agent's actions within the predetermined environment, and the results of those actions, are used to train a model for future behavior. For example, a reinforcement learning system may use training data that includes a set of objects or values that have predetermined relationships between them. During training, an agent may interact with the environment. Feedback from the environment, for example in the form of a reward value that is generated for each agent action, may be used to alter a policy that the agent uses to decide on its next action. Thus, by allowing the agent to explore the environment, a decision-making policy may be automatically generated.

However, these environments may be difficult to create by hand, which makes it difficult to implement systems that benefit from a variety of different environments. For complex environments in particular, where many different variables may interact with one another to determine the agent's reward for an action, providing a realistic scenario can be challenging. Furthermore, diversity in the training environments may be difficult to obtain.

### SUMMARY

A method for generating an environment includes training transformer models from tabular data and relationship information about the training data. A directed acyclic graph is generated, that includes the transformer models as nodes. The directed acyclic graph is traversed to identify a subset of transformers that are combined in order. An environment is generated using the subset of transformers. This provides automatically generated environments, which can be used to improve the efficacy of reinforcement learning by providing greater diversity of training environments.

A system for generating an environment includes a hardware processor a memory that stores a computer program product. When the computer program product is executed by the hardware processor, it causes the hardware processor to train transformer models from tabular data and relationship information about the training data, to generate a directed acyclic graph that includes the models as nodes, to traverse the directed acyclic graph to identify a subset of transformers that are combined in order, and to generate an environment using the subset of transformers. This provides automatically generated environments, which can be used to improve the efficacy of reinforcement learning by providing greater diversity of training environments.

The tabular data may further be transformed to introduce new columns to add time-dependent information to each row of the tabular data. This can help to capture past information within a single row of the tabular data, so that various transformer models can access such time-dependent information.

The directed acyclic graph may further include multiple distinct graphs, with no dependencies between transformer models of respective distinct graphs. This can make it possible to process the different graphs in parallel, as there is no ordering between the transformer models of distinct graphs.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram of an exemplary environment, which may be used to train a reinforcement learning model, in accordance with an embodiment of the present invention;

FIG. 2 is a diagram of an exemplary decision optimization transformer graph, which includes a number of distinct transformer pipelines, in accordance with an embodiment of the present invention;

FIG. 3 is a block/flow diagram of a method for generating and using an environment, using a decision optimization transformer graph, in accordance with an embodiment of the present invention;

FIG. 4 is a block/flow diagram of a method for obtaining training data that can be used to train the transformer pipelines of a decision optimization transformer graph, in accordance with an embodiment of the present invention;

FIG. 5 is a block/flow diagram of a method for constructing a decision optimization transformer graph, in accordance with an embodiment of the present invention;

FIG. 6 is a block/flow diagram of a method of transforming tabular training data to flatten time-dependent information, in accordance with an embodiment of the present invention;

FIG. 7 is a block diagram of an environment generation system, in accordance with an embodiment of the present invention;

FIG. 8 is a block diagram of an exemplary transformer pipeline, implemented as an artificial neural network, in accordance with an embodiment of the present invention;

FIG. 9 is a block diagram showing an illustrative cloud computing environment having one or more cloud computing nodes with which local computing devices used by cloud consumers communicate in accordance with one embodiment; and

FIG. 10 is a block diagram showing a set of functional abstraction layers provided by a cloud computing environment in accordance with one embodiment.

### DETAILED DESCRIPTION

To address the difficulty of generating training environments by hand, such as for reinforcement learning systems, environments may be automatically generated from high-level descriptions of an input application, domain knowledge, and tabular data. Toward this end, a decision optimization transformer model may be generated that includes multiple transformer pipelines, each of which can be used to generate a different component of an environment. These transformer pipelines may each be trained according to different combinations of model type, training data, and high-level model knowledge. The decision optimization transformer model may be represented as a directed, acyclic graph, where nodes of the graph are different transformer pipelines.

These environments may be used for any appropriate purpose. For example, reinforcement learning systems may train a machine learning model or artificial intelligence model, such as an agent, using actions that are performed within the context of the environment. The environment determines a reward or result of the action, which the reinforcement learning system uses to adjust parameters of the model. When the trained model is subsequently used, it will navigate through a new environment in a manner that is guided by the actions and rewards that took place during training.

Although reinforcement learning is specifically contemplated as a use for the automatically generated environments, it should be understood that they may be put to any appropriate purpose. For example, a reinforcement learning environment may be created automatically from a high-level application specification and tabular data for an inventory control system. In such an application, agents interact with the generated environment and learn to decide the right amounts to order to refill an inventory level, given a forecast of demand in the near future.

An environment that is generated from data and high-level domain knowledge may be used to simulate different decision-making policies. Such policies may include specific sets of rules or mappings that decision-makers may follow to determine how to act in any given state of the system. The overall performance of the policies may then be compared to rank and select preferred policies. Similarly, the environments may help with comparing, ranking, and selecting a preferred set of actions that a decision-maker may take, corresponding to any specific state that the decision-maker finds the system in.

The generated environment may also have a modular structure, since the environment may be created by combining multiple machine learning pipelines and orchestrating their calculations using a directed acyclic graph. This modular structure enables decision-makers to selectively replace any individual machine learning pipeline that is otherwise automatically created, using a customized formula such as a user-provided function or lookup table or rule. This flexibility makes it possible to generate environments that are in line with a user's expectations for a reasonable approximation of a real dynamic system.

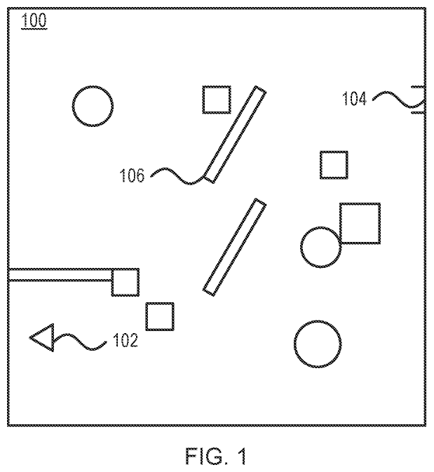

Referring now to the drawings in which like numerals represent the same or similar elements and initially to FIG. 1, an example of an environment 100 that may be used in reinforcement learning is shown. It should be understood that this environment is represented in a high-level, graphical manner, to reflect a visualization of a physical space, but environments may instead be represented as a set of rules that dictate how various agent actions affect the state of the agent and of the environment itself.

In this example, an agent 102 moves within a space that is occupied by various obstacles 106. The agent 102 has a goal of reaching an exit 104. With each action that the agent 102 performs, such as moving within the environment 100, a reward may be determined. For example, the reward may represent a decrease in distance to the exit and may further include information about collisions between the agent 102 and the obstacles 106.

The agent 102 may obtain varying types of information about the environment. For example, in some cases the agent 102 may be able to sense its surroundings, including distances to the obstacles 106. In another example, the agent 102 may operate without such sense information, and may instead learn to navigate the environment 100 based on a more limited set of data.

As will be addressed in greater detail below, the environment 100 may be generated as a combination of multiple transformer pipelines, where each pipeline model may represent a different kind of environment information and potential interactions. In some cases, different transformer pipelines may interact with one another, whereas others may be independent from one another.

Consider, for example, the following tabular data for an inventory control environment:

TABLE 1

| Date | Inventory | Demand | Cost | Order amount |
|---|---|---|---|---|
| 1 Jan. 2019 | 23 | 35 | 120 | 72 |
| 2 Jan. 2019 | 72 | 35 | 37 | 23 |
| 3 Jan. 2019 | 60 | 26 | 34 | 35 |
| 4 Jan. 2019 | 69 | 61 | 8 | 26 |
| 5 Jan. 2019 | 34 | 59 | 250 | 61 |
| 6 Jan. 2019 | 61 | 21 | 40 | 34 |
| 7 Jan. 2019 | 74 | 15 | 59 | 21 |
| 8 Jan. 2019 | 80 | 52 | 28 | 0 |

This information includes different states of the inventory control environment at different times, with a physical state of the environment being represented as the inventory, a believe state of the environment being represented as a demand forecast, and agent's actions being represented as the “order amount.”

High-level information may be provided by a user, for example specifying rules that govern interactions between the agent and the state of the environment. Following the inventory control environment example, the inventory at a time t may be based on the inventory at a time t−1, a number of past order amounts across previous time steps t−1, t−2, etc., and a previous demand at t−1. The inventory at the present time may therefore be represented as a function over these quantities, which may be learned from the input data.

In some cases, the functional relationship between these quantities may be learned from the input tabular data, using any of a variety of machine learning models. It should be understood that multiple different forms of model may be trained on the same tabular information, providing multiple different transformer pipelines. Exemplary forms of model may include linear regression models, logistic regression models, decision tree learning, support vector machines, random forest models, or any other appropriate machine learning model form. Some models may be more appropriate to particular kinds of input. For example, some models may better accommodate binary-valued inputs, while other models may be better suited to continuous-valued inputs.

The high-level information that describes general properties of the environment may be pre-determined by a user, without getting to the low-level definitions of the environment itself. For example, the high-level information may include a definition that indicates particular variables as being physical or belief states, actions, responses, and rewards or costs. The physical states may correspond to physically observed state variables, while the belief states may correspond to unobserved state variables. For example, a belief state may include distributional information about unknown parameters. The action variables may be decided by an agent at the start of each time step. The reward or cost variables may represent values that are incurred at the end of each time step.

The high-level information may also indicate how far back in time each variable is considered, and may capture state-transition dynamics. The high-level information may be represented in any appropriate manner, such as using extensible markup language (XML) or another appropriate data interchange format.

An exemplary transformer pipeline that may be learned from the above example is: iᵢ₊₁=F(iₜ, dₜ, oₜ, oₜ₋₁), where it is the inventory at time t, dₜ is the demand at time t, oₜ is an order amount at time t, and F is a function that represents the learned model to predict a next inventory iₜ₊₁. The function F may be represented a machine learning model with its own parameters, and may be expressed as a variety of different models F₁(⋅), F₂(⋅), etc.

Additionally, such models may be chained, with the output of one model forming the input of another. Following the above example, the value for the demand may be expressed as dₜ=G(dₜ₋₁, . . . , dₜ₋ₖ), where k is a number of timesteps back that the determination looks and G is a second machine learning model, which may be trained according to its own respective set of tabular data and high-level information. In this manner, different transformer pipelines may be combined to define an environment. Different versions of a given transformer may be used to provide different environments, and some environments may have more or fewer transformers in them.

The present models may be described in terms of transformers and estimators. A machine learning transformer may be understood as a function that takes first data as an input and outputs second data, while an estimator may be understood as a function that takes data as an input and outputs a transformer. For example, a transformer may be implemented as a machine learning model, while an estimator may be implemented as a training method that trains a machine learning model.

In addition, high-level decision-optimization transformers and decision-optimization estimators may be described. The decision-optimization transformer may include multiple machine learning transformers (described herein as transformer pipelines), which may be connected in various arrangements to output an automatically generated environment. The decision-optimization estimator may be interpreted as a downstream application, which makes use of the generated environment(s) to perform a task, such as performing reinforcement learning for a model.

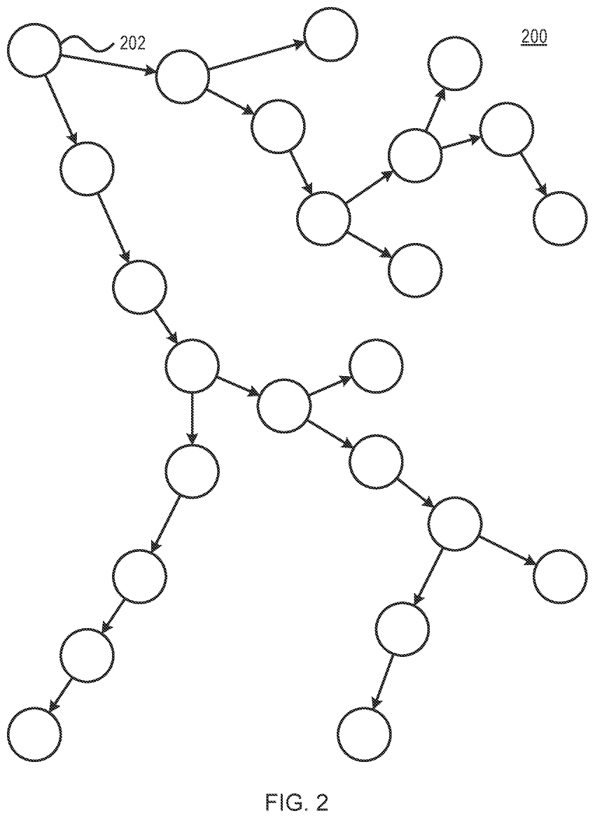

Referring now to FIG. 2, a directed, acyclic graph 200 is shown to represent an exemplary decision optimization transformer model. Each node 202 represents a different transformer pipeline. As described above, each of these transformer pipelines may be trained using a respective set of training data and respective high-level information. Some nodes 202 may be trained independently, whereas for others there may be interdependencies between models.

To generate an environment, one or more nodes 202 may be selected by traversing the graph 200. In some cases, an environment may be generated by traversing to a leaf node, with the generated environment being the combination of each of the traversed nodes 202. In some cases, the graph 200 may be partially traversed, for example without reaching a leaf node.

Each node 202 in the graph 200 may have a response (e.g., a target of the respective transformer pipeline), covariates (e.g., predictors of the respective transformer pipeline), a reference time start, and a reference time window. The response variable's name, covariates' variable names, and their reference times may be used to identify temporal or sequential dependencies between nodes. For example, for a first node and a second node, if the first node's response is the second node's covariate, and if the first node's reference time falls into the time window of the second node's covariate, then the first node may be executed before the second node, or an edge my be placed between the first node and the second node.

Although the graph 200 is described as a single graph, it should be understood that there may be multiple sub-different graphs, with different respective root nodes. These sub-graphs may be executed in parallel in the final environment, having no temporal or topological dependency that crosses between the nodes of different sub-graphs. Each graph or sub-graph may have multiple leaf nodes, representing the different possible environments that each graph or sub-graph can generate. Although relatively unstructured graphs are described herein, it should be understood that other forms of directed acyclic graph, such as a tree, may be used.

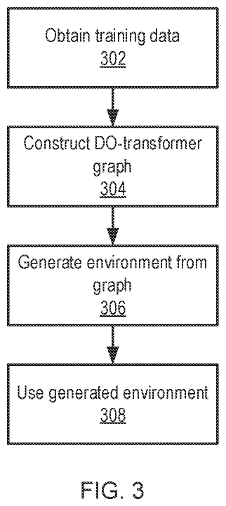

Referring now to FIG. 3, a method for generating and using an environment is shown. Block 302 obtains training data that reflects scenarios that may be taken account in the generated environment. In some cases, the training data may be generated by a user. In other cases, the training data may be drawn from real-world measurements. In other cases, the training data may be predetermined. In other cases, the training data may be gathered from a combination of sources. This training data may include a wide variety of different scenarios, each providing high-level information about the data, including relationships between the state of the scenario and actions that may be performed.

Block 304 constructs a decision-optimization transformer graph using the training data, as will be described in greater detail below. Block 306 uses the decision-optimization transformer graph to generate an environment, for example by traversing the graph to select a subset of transformer pipelines in the graph. Block 306 may determine one or more topological orderings within the directed acyclic graph. Environment may be constructed by traversing the graph according to topological orderings, node by node. For graphs that include unconnected nodes, or sub-graphs that are independent from one another, these nodes and sub-graphs may be executed in any order with respect to one another, and may be executed in parallel.

Block 308 then uses the generated environment. In one example, the generated environment may be used as an input to a reinforcement learning system, where a model may be trained to guide an agent through the generated environment. In another example, the generated environment may be used to test the performance of different policies.

It should be understood that sub-combinations of the steps of FIG. 3 may also have advantageous effects. For example, block 302 may be omitted, if training data is already available. Additionally, block 308 may be omitted, if the environment(s) that are generated are to be used by a different party. As noted above, the environments themselves are difficult to generate by hand, and so may represent a product unto themselves.

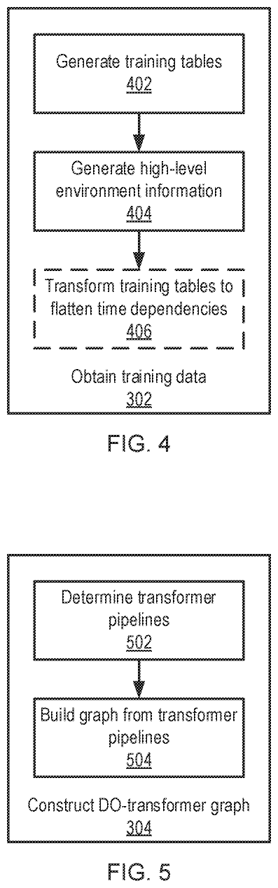

Referring now to FIG. 4, additional detail is provided for an example of obtaining training data in block 302 is shown. In this example, the training data may be generated by a user. Block 402 generates tables of training data. These tables include at least one variable that represents a state of a system and at least one variable that represents an action that is taken in a system. These variables may include, for example, observed and unobserved state variables, action variables, and cost or reward variables. The table shows states and actions taken at different times within the system.

Following the example of Table 1 above, this tabular data may represent pure numerical data. In another example, such as that shown in FIG. 1, the tabular data may represent other types of data, such as directional information, speed, and types of steering actions. The data may be generated by hand, or may be recorded according to the operation of an agent in a real-world environment. For example, the inventory data of FIG. 1 may track a real example of inventory management that captures the dynamics of such an environment. The time steps may be of a consistent length, as shown in FIG. 1 (e.g., one month), or may vary in length.

Block 404 generates high-level environment information that describes the information stored in the tabula data. For example, the different columns may be defined to capture the relationships between the variables represented by those columns. For example, the roles of different variables may be defined on a high level of abstraction. The high-level environment information may be generated by a user, for example in a definition file that uses any appropriate markup or notation format. The high-level information may include qualitative temporal relationships between the variables.

In some cases, the training tables may be further transformed to improve their usefulness in a variety of transformer types. For example, some columns of a table may have a time dependency, where the value of an entry in a column of the table may be influenced by earlier entries in that column. The amount of backward-looking context may vary from one column to another. While some types of transformers may be structured to handle time-dependent series (e.g., recurrent neural networks), other types of transformers may still provide useful environment information if the time-dependencies are captured in the input.

Toward that end, block 406 may optionally transform the training tables to flatten time dependencies. This “flattening” process is described in greater detail below. The transformation of block 406 may learn a number of time steps that are useful for understanding the context of a current value, and may add that number of previous values as additional columns of an input. In this manner, the time-sensitive information may be captured in a single input, for use in a variety of different transformer types.

Referring now to FIG. 5, additional detail is provided for an example of constructing the decision-optimization transformer graph in block 304 is shown. Using the training data, block 502 determines a set of transformer pipelines. The high-level information is used to generate the general structure of a model that represents the relationships between the variables of the tabular data. Following the example of Table 1, an exemplary transformer pipeline model may be expressed as iₜ₊₁=F(iₜ, dₜ, oₜ, oₜ₋₁). This transformer pipeline may then be trained using the tabular data associated with the high-level information, using any appropriate training process that is associated with the particular model being used.

As noted above, any appropriate form of model may be used. In some cases, multiple forms of model may be trained using a single set of training data. Thus, for each instance of tabular data and corresponding high-level information, multiple different transformer pipelines may be determined using different forms of model.

Block 504 builds a directed, acyclic graph from the transformer pipelines. The structure of the graph may be determined, at least in part, by interdependencies between transformer pipelines. For example, if a first pipeline makes use of a variable that is modeled by a second pipeline, then the second pipeline may be positioned before the first pipeline in the graph. Where multiple different transformer pipelines handle the same variables, the graph may branch. Topological ordering may be used to determine execution order within the graph that is built by block 504. To satisfy domain constraints and dependencies, transformer pipelines may have a particular order that they need to be executed in.

Each response and covariate of each node 202 of the graph 200 may have a lookback window knowledge element. The lookback window may be an integer, representing a fixed number of time steps, or may be automatically determined. When the lookback window is automatically determined, then a lookback window size for a given variable may be automatically determined. Automatic lookback window determination adds a dynamic to the graph 200, because edges between nodes may not be known in advance.

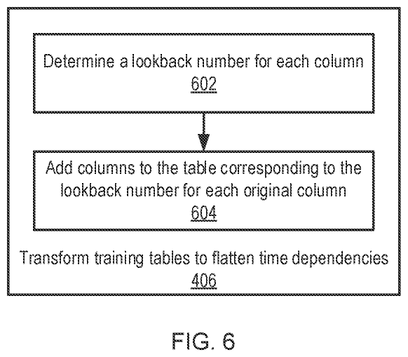

Referring now to FIG. 6, additional detail is shown on the transformation of training tables in block 406. As noted above, block 406 is optional, but may increase the effectiveness of various types of transformers. Block 602 determines a lookback number for each original column of a table of training data. The lookback number characterizes how much backward-looking context is useful. In some cases, the lookback number may be automatically determined, for example using a machine learning approach that identifies when a previous time entry has a below-threshold contribution to a present value.

Block 604 adds new columns to the table. For each original column of the table, a number of new columns is introduced that is equal to the lookback number for that original column. For example, if block 602 determines that the value of a current value in column A is sensitive the previous three values, then block 604 may introduce three new columns: A1, A2, and A3. The values for these columns may be set to the three previous values of column A. Following the example of Table 1 above, Table 2 shows an example where the Demand column has a lookback number of 2.

TABLE 2

| | | | Demand | Demand | | Order |
|---|---|---|---|---|---|---|
| Date | Inventory | Demand | 1 | 2 | Cost | amount |
| 1 Jan. 2019 | 23 | 35 | | | 120 | 72 |
| 2 Jan. 2019 | 72 | 35 | 35 | | 37 | 23 |
| 3 Jan. 2019 | 60 | 26 | 35 | 35 | 34 | 35 |
| 4 Jan. 2019 | 69 | 61 | 26 | 35 | 8 | 26 |
| 5 Jan. 2019 | 34 | 59 | 61 | 26 | 250 | 61 |
| 6 Jan. 2019 | 61 | 21 | 59 | 61 | 40 | 34 |
| 7 Jan. 2019 | 74 | 15 | 21 | 59 | 59 | 21 |
| 8 Jan. 2019 | 80 | 52 | 15 | 21 | 28 | 0 |

Notably, the rows may have gaps for some of the new columns, due to the lack of prior rows to draw values from. In some cases, where the number of rows is large compared to the lookback number, these initial rows may simply be omitted from the transformed table without significantly affecting performance. In some cases, the gaps may be filled with data drawn from the original column, such as by filling with mean or median values from the data of the original column. In some cases, any appropriate data imputation or inference may be used to fill in the gaps.

It should be noted that each of the columns may be transformed independently, and thus each column may be processed in parallel. Additionally, each original column may have a different lookback number, and so a different number of associated new columns. Original columns for both response variables and covariate variables may be transformed in this manner.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

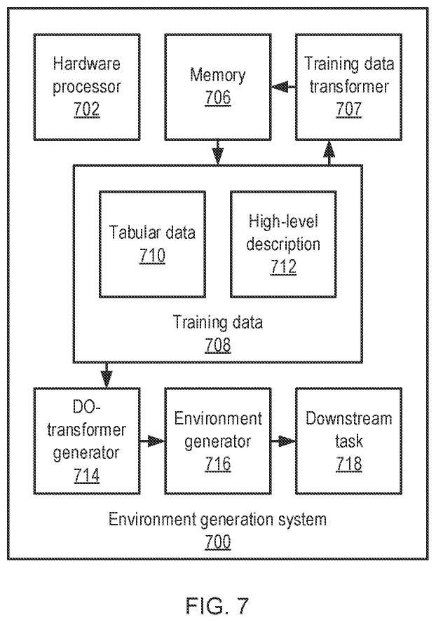

Referring now to FIG. 7, an environment generation system 700 is shown. The system 700 includes a hardware processor 702 and a memory 706. The system 700 may further include functional components which may each be implemented as software that is stored in the memory 706 and that is executed by the hardware processor 702 to perform its respective function. The functional modules may also be implemented in the form of one or more discrete hardware components, for example as application-specific integrated chips or field programmable gate arrays.

Training data 708 is stored in the memory 706. The training data 708 may include tabular data 710 and high-level description information 712. The training data 708 may be originally generated by a domain expert, or may be derived from real-world data. A training data transformer 707 may operate on the tabular data 710 to flatten time-sensitive columns, as described above, to capture time dependencies in the tabular data 710 in individual columns.

A decision optimization transformer generator 714 generates a decision optimization transformer graph, as described above, using the training data 708 to train transformers in accordance with the high-level description information 712. The graph is then used by an environment generator 716, which traverses the graph to build a set of environments. These environments are used by a downstream task 718, for example to be used in training a reinforcement learning model or in testing the efficacy of a decision policy in various circumstances.

The transformers of the graph may be implemented as, for example, artificial neural networks (ANNs). An ANN is an information processing system that is inspired by biological nervous systems, such as the brain. One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

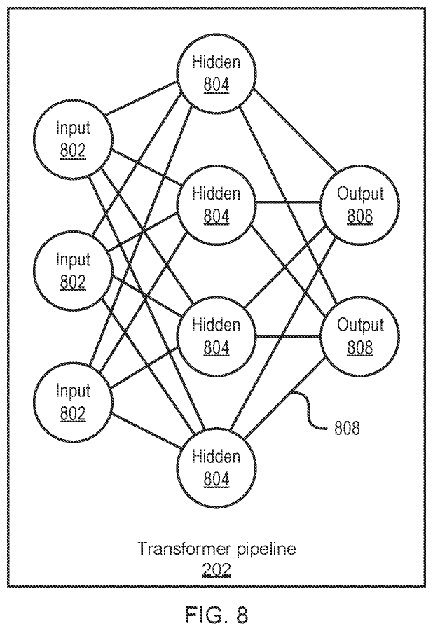

Referring now to FIG. 8, a generalized diagram of a neural network is shown, which may be used to implement an exemplary transformer pipeline 202 in a decision optimization transformer graph. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 802 that provide information to one or more “hidden” neurons 804. Connections 808 between the input neurons 802 and hidden neurons 804 are weighted, and these weighted inputs are then processed by the hidden neurons 804 according to some function in the hidden neurons 804. There can be any number of layers of hidden neurons 804, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 806 accepts and processes weighted input from the last set of hidden neurons 804.

This represents a “feed-forward” computation, where information propagates from input neurons 802 to the output neurons 806. Upon completion of a feed-forward computation, the output is compared to a desired output available from training data. The error relative to the training data is then processed in “backpropagation” computation, where the hidden neurons 804 and input neurons 802 receive information regarding the error propagating backward from the output neurons 806. Once the backward error propagation has been completed, weight updates are performed, with the weighted connections 808 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 808 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights 808 may be implemented as resistive processing units (RPUs), generating a predictable current output when an input voltage is applied in accordance with a settable resistance.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

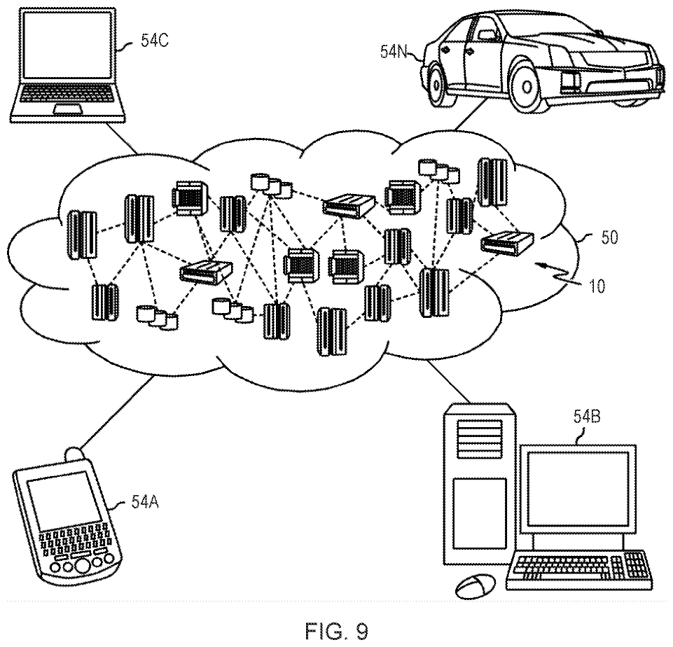

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. are intended to be illustrative only and that computing nodes 10 and cloud computing environment 50 can communicate with any type of computerized device over any type of network and/or network addressable connection (e.g., using a web browser).

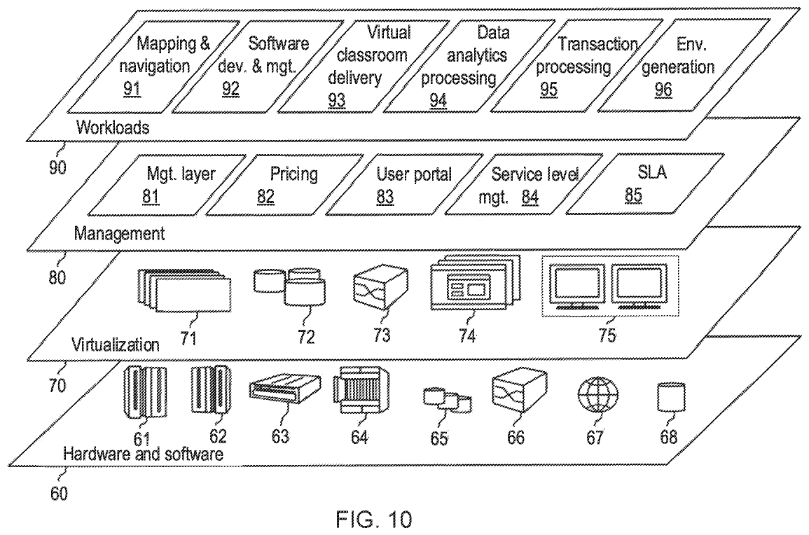

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and environment generation 96.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for generating an environment, comprising:
training a plurality of transformer models from tabular data and relationship information about the training data;
generating a directed acyclic graph that includes the plurality of transformer models as nodes;
traversing the directed acyclic graph to identify a subset of transformers that are combined in order; and
generating an environment using the subset of transformers.

2. The method of claim 1, further comprising transforming the tabular data to introduce new columns to add time-dependent information to each row of the tabular data, before determining the plurality of transformer models.

3. The method of claim 2, further comprising determining a lookback number for each original column in the tabular data, wherein transforming the tabular data includes adding a number of new columns for each original column equal to the lookback number for the respective original column.

4. The method of claim 1, wherein the directed acyclic graph includes multiple distinct graphs, with no dependencies between transformer models of respective distinct graphs.

5. The method of claim 4, wherein traversing the directed acyclic graph includes traversing the multiple distinct graphs in parallel.

6. The method of claim 1, wherein the relationship information includes relationships between columns of the tabular data.

7. The method of claim 1, wherein each of the plurality of transformer models is trained using a distinct combination of tabular data and model type.

8. The method of claim 7, wherein at least some of the plurality of transformer models are implemented as neural network models.

9. The method of claim 1, further comprising training a machine learning model using reinforcement learning, based on the environment.

10. The method of claim 1, further comprising executing a decision policy using the environment to test the decision policy in new circumstances.

11. A computer program product for generating an environment, the computer program product comprising a computer readable storage medium having program instructions embodied therewith, the program instructions being executable by a hardware processor to cause the hardware processor to:
train a plurality of transformer models from tabular data and relationship information about the training data;
generate a directed acyclic graph that includes the plurality of transformer models as nodes;
traverse the directed acyclic graph to identify a subset of transformers that are combined in order; and
generate an environment using the subset of transformers.

12. A system for generating an environment, comprising:
a hardware processor; and
a memory that stores a computer program product, which, when executed by the hardware processor, causes the hardware processor to:
train a plurality of transformer models from tabular data and relationship information about the training data;
generate a directed acyclic graph that includes the plurality of transformer models as nodes;
traverse the directed acyclic graph to identify a subset of transformers that are combined in order; and
generate an environment using the subset of transformers.

13. The system of claim 12, wherein the computer program product further causes the hardware processor to transform the tabular data to introduce new columns to add time-dependent information to each row of the tabular data, before the plurality of transformer models are determined.

14. The system of claim 13, wherein the computer program product further causes the hardware processor to determine a lookback number for each original column in the tabular data, wherein the transformation of the tabular data includes the addition of a number of new columns for each original column equal to the lookback number for the respective original column.

15. The system of claim 12, wherein the directed acyclic graph includes multiple distinct graphs, with no dependencies between transformer models of respective distinct graphs.

16. The system of claim 15, wherein the computer program product further causes the hardware processor to traverse the multiple distinct graphs in parallel.

17. The system of claim 12, wherein the relationship information includes relationships between columns of the tabular data.

18. The system of claim 12, wherein each of the plurality of transformer models is trained using a distinct combination of tabular data and model type.

19. The system of claim 18, wherein at least some of the plurality of transformer models are implemented as neural network models.

20. The system of claim 12, wherein the computer program product further causes the hardware processor to train a machine learning model using reinforcement learning, based on the environment.
